(19) United States
(12) Patent Application Publication
(10) Pub. No.: US 2026/0177190 A1
(43) Pub. Date: Jun. 25, 2026

(54) MONITOR MOUNT

(71) Applicant: TILTA INC., Burbank, CA (US)

(72) Inventors: Weihan SHE, Shenzhen (CN); Wenping ZENG, Shenzhen (CN); Kefeng ZHOU, Shenzhen (CN)

(21) Appl. No.: 19/423,194

(22) Filed: Dec. 17, 2025

(30) Foreign Application Priority Data
Dec. 20, 2024 (CN) 202423194319.0

(51) Int. Cl. F16M 11/04; F16M 11/10; G06F 1/16

(52) U.S. Cl. CPC F16M 11/041; F16M 11/10; G06F 1/1601; F16M 2200/024

(57) ABSTRACT

A mounting base for connecting to a monitor is disclosed. The mounting base includes: a rotation position; a main bracket body including a rotating part, said rotating part being rotatably disposed at the rotation position about a first axis and having a locking position; and a locking member capable of moving relative to the mounting base to engage with the locking position. In some aspects, the monitor mount of the present application, by providing a locking member movable relative to the main bracket body, enables the locking member to engage with the locking position when rotation of the monitor is not required, thereby locking the rotation between the main bracket body and the mounting base. This prevents the monitor from shifting during transportation or use, thus improving structural stability.

### CROSS-REFERENCE TO RELATED APPLICATIONS

The present application for patent claims priority to and the benefit of pending Chinese Application No. 202423194319.0, filed Dec. 20, 2024, and hereby expressly incorporated by reference herein as if fully set forth below in its entirety and for all applicable purposes.

### TECHNICAL FIELD

The present disclosure pertains to the field of photographic accessories, specifically to a monitor mount.

### INTRODUCTION

During filming with photographic equipment, the screen integrated into the camera is typically small, necessitating the use of a monitor to enable staff to view the shooting footage in real time more effectively.

The monitor provides real-time feedback of the camera's shooting screen, offering high-definition image previews. This aids photographers and directors in reviewing shots in real time, ensuring that aspects such as composition, exposure, and color meet expectations.

When utilizing a monitor, a monitor mount is generally required. Existing monitor mounts typically include a mounting base and a connecting member. The connecting member and the mounting base can be connected in a damped rotational manner, allowing users to adjust the monitor's angle. However, in certain situations, due to the monitor's weight or during transportation, the mounting base and the connecting member may still shift relative to each other despite the damping, leading to structural instability.

### BRIEF SUMMARY

Aspects of the present disclosure provide a monitor mount capable of preventing the monitor from shifting during transportation or use, featuring a more stable structure.

Aspects of the present disclosure provide a monitor mount including:
A mounting base for connecting to a monitor, including a rotation position;
a main bracket body including a rotating part, the rotating part being rotatably disposed at the rotation position about a first axis and having a locking position;
a locking member capable of moving relative to the mounting base to engage with the locking position.

The beneficial effect of the present disclosure is that, compared with the prior art, the monitor mount of the present disclosure provides a locking member that is movable relative to the main bracket body, and configured to engage with the locking position when rotation of the monitor is not required, thereby locking the rotation between the main bracket body and the mounting base. This prevents the monitor from shifting during transportation or use, thus improving structural stability of the mounting assembly.

### BRIEF DESCRIPTION OF THE DRAWINGS

FIG. 1 is a schematic diagram illustrating a monitor mount with a monitor according to some aspects of the disclosure.

FIG. 2 is a schematic diagram illustrating a main bracket body according to some aspects of the disclosure.

FIG. 3 is a schematic diagram illustrating a mounting base according to some aspects of the disclosure.

FIG. 4 is an exploded view illustrating the mounting base and a locking member according to some aspects of the disclosure.

FIG. 5 is a schematic diagram illustrating an assembly state of the mounting base (with the cover hidden) and the locking member according to some aspects of the disclosure.

FIG. 6 is a schematic diagram illustrating the assembly state of a quick-release base and the quick-release plate according to some aspects of the disclosure.

FIG. 7 is a schematic cross-sectional view of the connection between a rotating part and the monitor.

Reference Numerals: 1. main bracket body; 11. rotating part; 111. locking position; 1111. first rotating part; 1112. second rotating part; 1113. engagement groove; 12. support arm; 13. stopper post; 2. monitor; 3. mounting base; 31. rotation position; 311. rotation groove; 3111. first rotation groove; 3112. second rotation groove; 32. first pivot shaft; 33. limiting groove; 34. quick-release base; 341. mounting groove; 342. second pivot shaft; 343. base body; 344. cover; 35. quick-release plate; 351. locking groove; 36. locking member; 361. locking part; 362. locking handle; 363. locking rotary part; 364. anti-detachment hook; 37. anti-detachment member; 371. anti-detachment groove; 38. second elastic member; 39. mounting plate; 4. locking member; 41. locking lug; 42. locking handle; 43. locking rotary part; 5. first elastic member.

### DETAILED DESCRIPTION

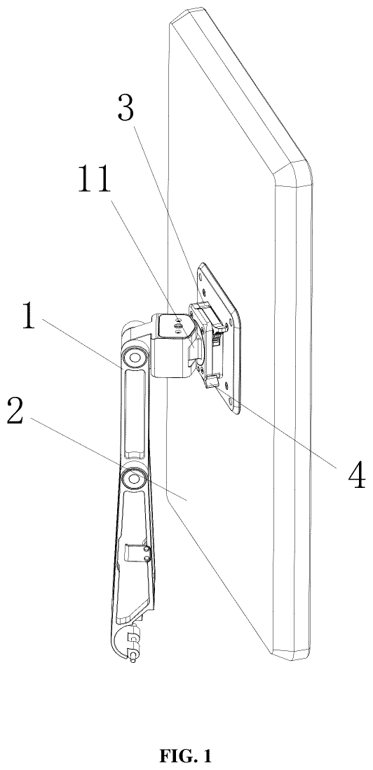

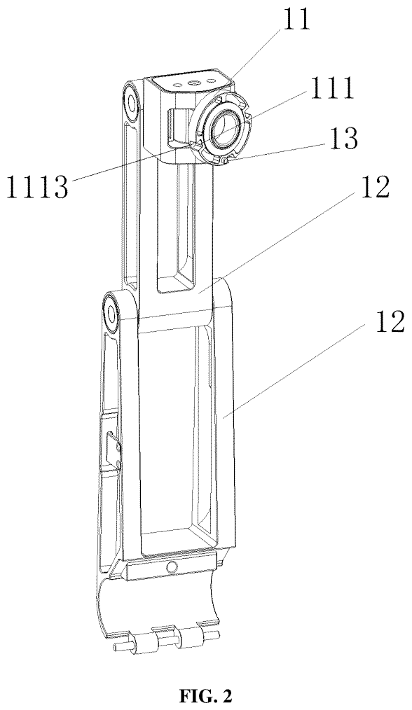

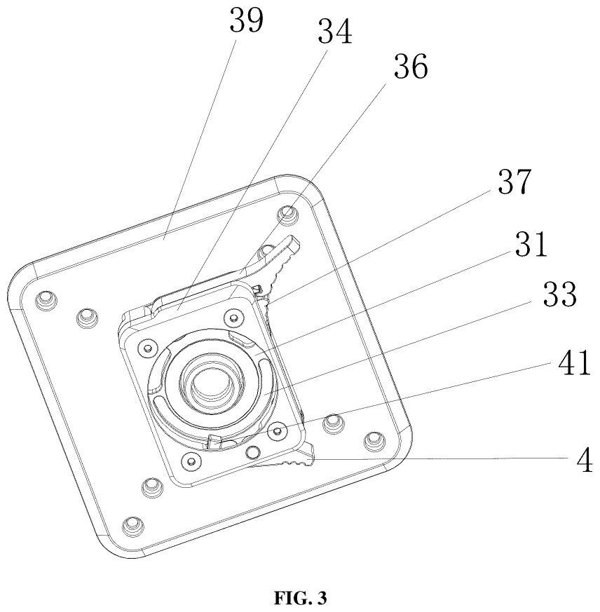

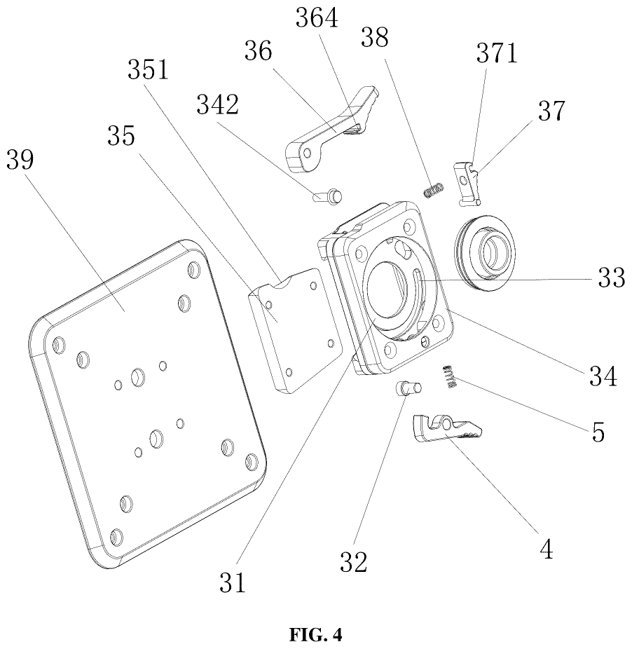

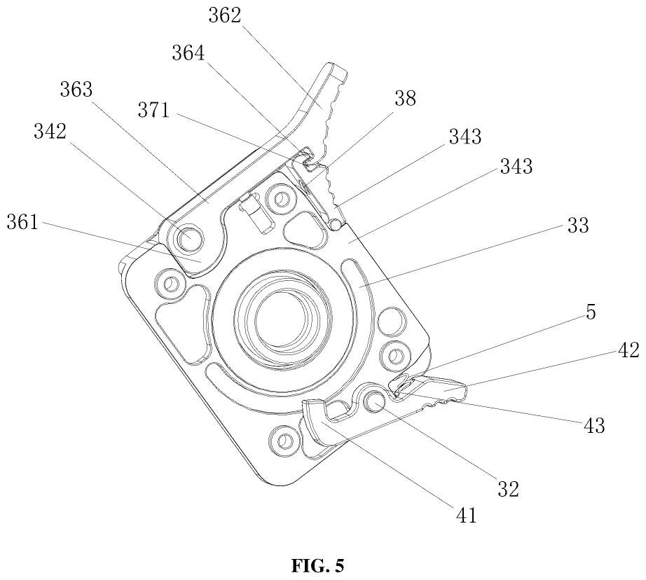

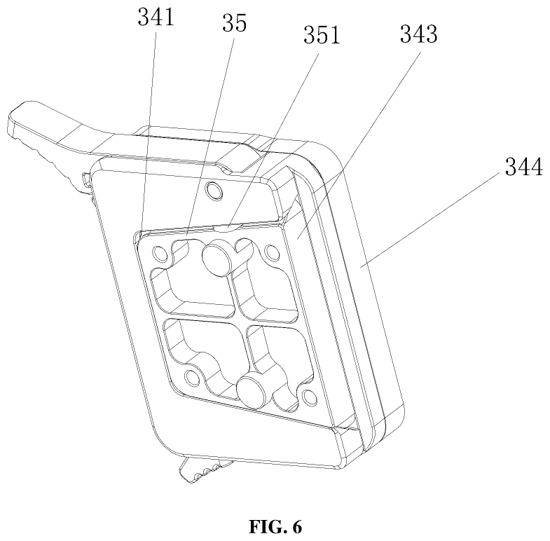

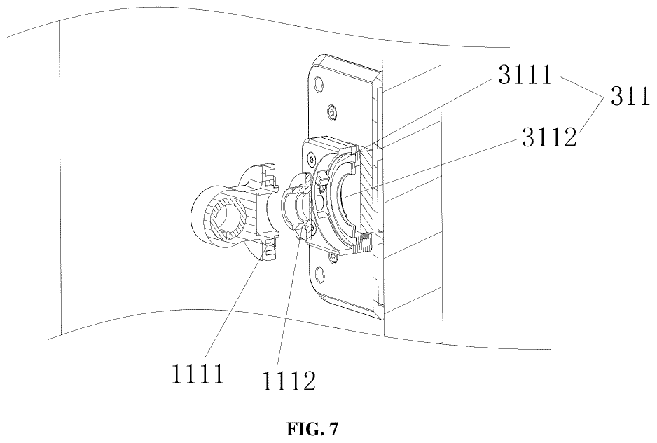

Referring to FIGS. 1-7, aspects of the present disclosure provide a monitor mount including:
a mounting base 3 for connecting to a monitor 2, having a rotation position 31;
a main bracket body 1 including a rotating part 11, the rotating part 11 being rotatably disposed at the rotation position 31 about a first axis and having a locking position 111; and
a locking member 4 configured to move relative to the mounting base 3 to engage with the locking position 111.

Since the locking member 4 can move relative to the main bracket body 1, it can engage with the locking position 111 to limit movement between the main bracket body 1 and the mounting base 3. The locking member 4 can also disengage from the locking position 111 to facilitate rotation between the mounting base 3 and the main bracket body 1. Through this structural design, during product transportation or normal use when monitor rotation is not required, the locking member 4 can engage with the locking position 111 to lock the rotation between the main bracket body 1 and the mounting base 3, preventing the monitor 2 from shifting during transportation or use, thereby improving structural stability. When adjustment of the monitor angle is needed, the locking member 4 can be moved away from the locking position 111, releasing the rotating part 11 to facilitate its rotation for adjusting the monitor's angle.

In some aspects, the main bracket body 1 can be formed by connecting multiple support arms 12 together. In one example, the multiple support arms 12 are pivotally connected to each other, facilitating adjustment of the support position of the main bracket body 1 and also facilitating folding and storage of the main bracket body 1. In some aspects, the rotating part 11 is rotatably connected to the mounting base 3 about the first axis. In one example, the rotation position 31 includes a rotation groove 311. The rotating part 11 is rotatably disposed within the rotation groove 311. A gasket can be provided between the rotating part 11 and the wall of the rotation groove 311. In one example, the rotation groove 311 includes a first rotation groove 3111 and a second rotation groove 3112. The rotating part 11 includes a connected first rotating part 1111 and a second rotating part 1112. The first rotating part 1111 is rotatably disposed in the first rotation groove 3111. The second rotating part 1112 is rotatably disposed in the second rotation groove 3112. The first axial direction is the axial direction of the second rotating part 1112.

In some aspects, the locking position 111 employs an engagement groove 1113 opened on the rotating part 11. The locking member 4 includes a locking lug 41 shaped to match the engagement groove 1113. The engagement groove 1113 is configured to be inclined in the direction facing the locking path of the locking lug 41, so that when locking the rotating part 11 is required, the locking lug 41 can engage into the engagement groove 1113.

In some aspects, the locking member 4 also includes a locking handle 42 and a locking rotary part 43. One end of the locking rotary part 43 is fixedly connected to the locking handle 42, and the other end is fixedly connected to the locking lug 41. The mounting base 3 includes a first pivot shaft 32. The locking rotary part 43 is rotatably connected to the first pivot shaft 32. The locking member 4 is rotatably connected to the mounting base 3 via the locking rotary part 43, using the mounting base 3 as a fixed body to mount and secure the locking member 4. During use, by operating the locking handle 42, the locking lug 41 can be driven to rotate about the first pivot shaft 32, enabling the locking lug 41 to move relative to the locking position 111 to engage with or disengage from the locking position 111.

In some aspects, the rotating part 11 also has a stopper post 13. The mounting base 3 can include one or more limiting grooves 33. The stopper post 13 is movably disposed within the corresponding one of limiting grooves 33. For example, the limiting groove 33 can be a 180-degree arc-shaped groove. Through the arrangement of the above structure, when the rotating part 11 rotates relative to the mounting base 3, the structure formed by the cooperation of the limiting groove 33 and the stopper post 13 provides a rotational limit, thereby preventing excessive rotation. The limiting groove 33 (e.g., a 180-degree arc-shaped groove) allows the rotating part 11 to be rotationally limited within, for example, a 180-degree range, meeting the rotation needs of the monitor 2.

In some aspects, the stopper post 13 is disposed on the surface of the rotating part 11 facing the rotation position 31. The limiting groove 33 is disposed on the side wall of the rotation position 31. This allows the stopper post 13 to be concealed between the mounting base 3 and the rotating part 11, preventing the stopper post 13 from being exposed and potentially causing structural interference.

In some aspects, a first elastic member 5 can be also arranged between the locking member 4 and the mounting base 3. One end of the first elastic member 5 abuts against or is connected to the mounting base 3, and the other end abuts against or is connected to the locking handle 42. In some aspects, during normal use, the first elastic member 5 can abut against the locking handle 42, causing the locking lug 41 at the other end of the locking member 4 to engage with the locking position 111, achieving locking between the mounting base 3 and the main bracket body 1 and preventing the monitor 2 from shifting.

In some aspects, the mounting base 3 also includes a quick-release base 34 and a quick-release plate 35 for connecting to the monitor 2. The quick-release base 34 is provided with a mounting groove 341. The quick-release plate 35 is disposed within the mounting groove 341, and the quick-release plate 35 is detachably connected to the quick-release base 34. The rotation position 31 and the limiting groove 33 are both disposed on the quick-release base 34. The locking member 4 is rotatably connected to the quick-release base 34. The quick-release base 34 is configured to mount the rotating part 11, achieving a rotational connection with the main bracket body 1. The quick-release plate 35 is configured to connect to the monitor 2. The detachable connection between the quick-release plate 35 and the quick-release base 34 enables rapid assembly and disassembly between the main bracket body 1 and the monitor 2.

In some aspects, the mounting base 3 can include a locking member 36. The locking member 36 is movably connected to the quick-release base 34. The quick-release plate 35 can have a locking groove 351. The locking member 36 is configured to engage with the locking groove 351. Through the above structural design, the locking member 36 can be movably connected to the quick-release base 34 to engage with or disengage from the locking groove 351. During assembly, by engaging the locking member 36 with the locking groove 351, the quick-release plate 35 is locked within the mounting groove 341 of the quick-release base 34, preventing movement between the quick-release base 34 and the quick-release plate 35. During disassembly, the locking member 36 is moved out of the locking groove 351, disengaging from the locking groove 351 and releasing the quick-release plate 35. The quick-release plate 35 can then be removed from the mounting groove 341, achieving disassembly between the quick-release base 34 and the quick-release plate 35.

In some aspects, the locking member 36 includes a locking part 361, a locking handle 362, and a locking rotary part 363. Both the locking part 361 and the locking handle 362 are connected to the locking rotary part 363. The locking part 361 engages with the locking groove 351. The quick-release base 34 is provided with a second pivot shaft 342. The locking rotary part 363 is rotatably connected to the second pivot shaft 342. The locking member 36 is rotatably connected to the quick-release base 34 via the locking rotary part 363, using the quick-release base 34 as a fixed body to mount and secure the locking member 36. During use, by operating the locking handle 362, the locking part 361 can be driven to rotate about the second pivot shaft 342, enabling the locking part 361 to move relative to the locking groove 351 to engage with or disengage from the locking groove 351. In some examples, the locking member 36 and locking member 4 can be located on opposite sides of the quick-release base 34 or engage opposite sides of the release plate 35.

In some aspects, the locking part 361 can include a protruding post with an eccentric structure. The locking groove 351 can be an eccentric arc-shaped groove. This design leverages the characteristics of the eccentric structure. For example, when the locking part 361 rotates to different angles, it will either disengage from or engage with the locking groove 351.

In some aspects, the mounting base 3 can include an anti-detachment member 37. The anti-detachment member 37 is movably connected to the quick-release base 34. The locking member 36 can feature an anti-detachment hook 364, while the anti-detachment member 37 has an anti-detachment groove 371. The anti-detachment hook 364 can be movably engaged within the anti-detachment groove 371.

In some aspects, a second elastic member 38 can be positioned between the anti-detachment member 37 and the quick-release base 34. During normal use, the anti-detachment member 37 is rotatably connected to the quick-release base 34 via hinge shafts at both ends. Supported and abutted by the second elastic member 38, the anti-detachment hook 364 is engaged within the anti-detachment groove 371. Consequently, the locking member 36 is locked to the anti-detachment member 37, ensuring that the locking part 361 remains engaged within the locking groove 351, thereby achieving locking between the quick-release base 34 and the quick-release plate 35. When the monitor 2 needs to be detached, pressing the anti-detachment member 37 towards one side of the quick-release base 34 causes the anti-detachment member 37 to rotate relative to the quick-release base 34. As a result, the anti-detachment hook 364 disengages from the anti-detachment groove 371, releasing the locking member 36. The locking member 36 can then move, allowing the locking part 361 to be rotated and releasing the quick-release plate 35. Subsequently, the quick-release plate 35 can be removed from the quick-release base 34, achieving the detachment of the monitor 2.

In some aspects, the mounting base 3 can include a mounting plate 39. The quick-release plate 35 is fixed to the mounting plate 39, and the side of the mounting plate 39 away from the quick-release plate 35 is fixed to the monitor 2.

In some aspects, the quick-release base 34 is composed of a base body 343 and a cover 344, which are fixedly connected. The locking member 4, the locking member 36, and the anti-detachment member 37 are all positioned between the base body 343 and the cover 344 and are rotatably connected to the base body 343. The rotation position 31 is located on the cover 344, the limiting groove 33 is opened on the cover 344, and the mounting groove 341 is located on the base body 343.

The above descriptions represent exemplary embodiments of the present disclosure and are not intended to limit the scope of the present disclosure. Any modifications, equivalent replacements, and improvements made within the spirit and principles of the present disclosure shall be included within the protection scope of the present disclosure.

What is claimed is:

1. A monitor mount comprising:
a mounting base configured for connection to a monitor, comprising a rotation position;
a main bracket body comprising a rotating part, wherein the rotating part is rotatably disposed at the rotation position about a first axis, and the rotating part is provided with a locking position; and
a locking member configured to move relative to the mounting base to engage with the locking position.

2. The monitor mount according to claim 1, wherein the rotating part comprises multiple locking positions;
wherein the multiple locking positions are provided on the rotating part around the first axis; and
wherein the locking member is configured to engage with one of the multiple locking positions.

3. The monitor mount according to claim 2, wherein at least one of the multiple locking positions is provided with an engagement groove; and
wherein the engagement groove is configured to be inclined in a direction toward a locking path of the locking member, thereby facilitating engagement of the locking member into the engagement groove.

4. The monitor mount according to claim 1, wherein the locking position comprises an engagement groove formed on the rotating part;
wherein the locking member is elastically provided on the mounting base; and
wherein the locking member comprises a locking lug configured to engage with the engagement groove.

5. The monitor mount according to claim 4, wherein the locking member further comprises a locking handle and a locking rotary part;
wherein a first end of the locking rotary part is fixedly connected to the locking handle, and a second end of the locking rotary part is fixedly connected to the locking lug; and
wherein the mounting base comprises a first pivot shaft, and the locking rotary part is pivotally connected to the mounting base via the first pivot shaft.

6. The monitor mount according to claim 1, wherein the rotating part is further provided with one or more stopper posts;
wherein the mounting base is further provided with one or more limiting grooves; and
wherein the one or more stopper posts are movably disposed within the corresponding limiting grooves.

7. The monitor mount according to claim 1, wherein the rotating part=is further provided with one or more limiting grooves;
wherein the mounting base further comprises one or more stopper posts; and
wherein one or more stopper posts are movably disposed within the corresponding one or more limiting grooves.

8. The monitor mount according to claim 1, wherein the mounting base further comprises a quick-release base, a locking member, and a quick-release plate for connecting to a monitor;
wherein the rotation position is disposed on the quick-release base;
wherein the locking member is pivotally connected to the quick-release base;
wherein the quick-release base is provided with a mounting groove; and
wherein the locking member is movably connected to the quick-release base to lock or release the quick-release plate in the mounting groove.

9. The monitor mount according to claim 8, wherein the quick-release plate is provided with a locking groove; and wherein the locking member is configured to engage with the locking groove.

10. The monitor mount according to claim 9, wherein the locking member comprises a locking part, a locking handle, and a locking rotary part;
wherein the locking part and the locking handle are both connected to the locking rotary part;
wherein the locking part is configured to engage with the locking groove;
wherein the quick-release base is provided with a second pivot shaft; and
wherein the locking rotary part is pivotally connected to the quick-release base via the second pivot shaft.

11. The monitor mount according to claim 10, wherein the locking part comprises an eccentric-shaped protruding post.

12. The monitor mount according to claim 8, wherein the mounting base further comprises an anti-detachment member movably connected to the quick-release base;
wherein the locking member is provided with an anti-detachment hook;
wherein the anti-detachment member is provided with an anti-detachment groove; and
wherein the anti-detachment hook is movably engaged within the anti-detachment groove.
